(19) United States
(12) Patent Application Publication
(10) Pub. No.: US 2015/0356125 A1
(43) Pub. Date: Dec. 10, 2015

(54) METHOD FOR DATA PLACEMENT BASED ON A FILE LEVEL OPERATION

(71) Applicant: PLEXISTOR LTD., HERZLIYA (IL)

(72) Inventors: AMIT GOLANDER, TEL-AVIV (IL); BOAZ HARROSH, TEL-AVIV (IL); OMER ZILBERBERG, HAIFA (IL)

(21) Appl. No.: 14/658,264

(22) Filed: Mar. 16, 2015

Related U.S. Application Data
(60) Provisional application No. 62/008,552, filed on Jun. 6, 2014.

(51) Int. Cl. G06F 17/30

(52) U.S. Cl. CPC G06F 17/30309; G06F 17/30581; G06F 17/30864

(57) ABSTRACT

Data placement in a memory-based file system by copying a user data unit from a second storage type device to a first storage type device based on an access request to the file system, the first storage type device being a faster access device than the second storage type device, referencing the user data unit in the first storage type device by a byte addressable memory pointer, and using the byte addressable memory pointer to copy the user data unit from the first storage type device to the second storage type device based on data access pattern.

### CROSS-REFERENCE TO RELATED APPLICATIONS

This application claims the benefit of priority from U.S. Provisional Patent Application No. 62/008,552, filed Jun. 6, 2014, which is incorporated herein by reference in its entirety.

### FIELD OF THE INVENTION

This invention relates to the field of data placement in tiered data systems and in particular to data placement based on file level operations such as system calls.

### BACKGROUND

Data storage systems sometimes include different speed storage type devices, also named tiers. A fast access tier (e.g., consisting of a flash based solid-state drive (SSD)) will typically have a lower latency in accessing data than a slow access tier (e.g., consisting of a hard disk drive (HDD)). Ideally, all data should be available on high-speed fast access devices all the time to reduce the latency for retrieving data, however, this may prove to be too expensive. Automated tiering is a known solution to data storage system performance and cost issues wherein most systems store data on the fast SSD and move the data to slower devices if the data becomes “cold”, i.e. isn't accessed for a long period of time.

Advanced storage software, automatically make data placement decisions to the different tiers based on scheduled intervals or on specified attributes, such as data usage or last access. Automated tiering algorithms may make best guesses as to which data can be safely moved to a slow access tier and which data should stay in the fast access tier.

Typically, automated tiering software does not operate at the local file system level and is thus unaware of some system calls. Rather, most automated tiering software reside on a shared storage server, across the network and client-side software (e.g. NAS client or SAN initiator) that mask most system calls. Moreover, most automated tiering software monitor read and write access to data units (such as blocks) and are unaware that a set of specific data units comprises a single file. In such systems data is moved at a fine-grain block level.

Typically, SSDs are sufficiently priced and large enough to hold non-cold data, for instance, all data that was used in the last few days. Accordingly, a relatively large amount of data may be stored in the SSD fast access tier and most automated tiering software algorithms are designed to search the SSD fast access tier for cold data to be moved to the slow access tier. At these granularities distinguishing between read and write accesses and file level open and close system calls is meaningless. Thus, automated tiering algorithms make best guesses or predictions based on the accessed data unit granularity and do not take file level requests into consideration. Indeed, making data placement decisions based on file level operations provides no advantage for SSD fast access tiers.

Persistent memory (PM) is a newly emerging technology which is capable of storing data such that it can continue to be accessed using machine level instructions (e.g. memory load/store) even after a power failure. PM can be implemented through a nonvolatile media attached to the central processing unit (CPU) of the computer.

PM is characterized by low RAM-like latencies being 1,000 to 100,000 times faster per access than the flash and HDD memories respectively.

Given the superior performance of the emerging fast PM and the lower cost of traditional storage (SSD or HDD) and emerging slower PM, both technologies may be used to create a cost-efficient data storing solution.

A few emerging PM-aware file systems (e.g. EXT4-DAX) directly access the PM, avoiding the expensive and cumbersome caching and/or memory map services of the VFS layer. However, these systems do not support tiering, as they all assume that the entire data set resides in a homogenous PM space. Also, when compared with PM latencies the latency between file level operations and data unit access is significant however known automated tiering solutions do not take this latency into account and are not adjusted to PM low latencies. Thus, to date, there is no automated tiering solution appropriate for a PM based storage system.

### SUMMARY

Embodiments of the invention enable making data placement decisions which are proactive, taking into consideration file level (intra file and/or inter-file level) operations in order to predict data unit granularity operations and make decisions based on the predictions. Thus, data placement decisions can be implemented before the user accesses any data, saving time and enabling efficient utilization of ultra-fast storage devices, such as PM based media.

Thus, embodiments of the invention provide a solution for increasing demand in performance, capacity and ease of management of data in data storage systems.

In one embodiment a method for data placement in a file system includes issuing a speculated access request to a data unit, the data unit being a subset of a file, based on a file open request to the file and copying the data unit from a slow access tier to a fast access tier based on the issuing of the speculated access request.

In one embodiment the file open request may include an append argument and copying the data unit from the slow access tier to the fast access tier includes copying a data unit from the end of the file, typically when the end of the file is misaligned with boundaries of the data unit.

In one embodiment the method may include setting a right-append-hint attribute on the file after the file open request and based on the right-append-hint attribute and on an access request allocating a new data unit at the end of the file. A data unit previously at the end of the file is marked for copying from the fast access tier to the slow access tier.

In one embodiment an open file request to a file having a file name extension that matches a pre-defined set of name extensions causes issuing a speculated access request.

In one embodiment the method includes issuing the speculated access request based on a short history of access to the file. In this case the method may include setting a left-append-hint attribute on the file after the file open request and based on the left-append-hint attribute and following an access request, allocating a new data unit at the beginning of the file and marking a data unit previously at the beginning of the file for copying from the fast access tier to the slow access tier.

In one embodiment the method includes determining if the file open request comprises an append argument; if not determining if the file has a file name extension that matches a pre-defined set of name extensions; if not determining if the file is of size smaller than a pre-determined threshold; and if not issuing the speculated access request based on a short history of access to the file.

In one embodiment, based on a file open request to a first file in a directory, a speculated file open request is issued to a second file in the directory and a speculated access request is issued based on the speculated file open request.

In one embodiment the speculated file open request is issued based on a short history of open file requests. A speculated argument may be issued based on the speculated file open request and the speculated access request may be issued based on the speculated argument.

In some embodiments data units that were accessed may be maintained in a first list in the fast access tier and data units that were issued a speculated access request may be maintained in a second list in the fast access tier. Data units in the second list may be moved to the head of the first list upon an access request.

In one embodiment, based on a final close request to the file, all data units of the file which are saved in the fast access tier are marked for being moved from a fast access tier to a slower access tier. The fast access tier may be maintained into a list of data units in which data units are moved from the head of the list to the tail of the list and from the tail of the list to the slower access tier. Marking all data units of the file may include moving all the data units of the file into the list.

In one embodiment the method may include moving a data unit from the list upon access to the data unit and maintaining the data unit in the fast access tier.

In one embodiment access to the data unit may include issuing a speculated access to the data unit based on a file open request to a file containing the data unit.

In some embodiments of the invention a data storage system includes a fast access storage device (e.g., which includes a non-volatile PM module), a slower access storage device, and a processor to issue a speculated access request to a data unit (the data unit being a subset of a file) based on a file open request to the file and to copy the data unit from the slower access storage device to the fast access storage device based on the issuing of the speculated access request.

### BRIEF DESCRIPTION OF THE DRAWINGS

The invention will now be described in relation to certain examples and embodiments with reference to the following illustrative figures so that it may be more fully understood. In the drawings:

FIGS. 1A and 1B schematically illustrate an exemplary system according to embodiments of the invention;

FIG. 2 schematically illustrates a method for data placement in a file system, according to embodiments of the invention;

FIGS. 3A-3D schematically illustrate a method for data placement in a file system based on intra-file hints, according to embodiments of the invention;

FIG. 4 schematically illustrates a method for data placement in a file system including marking data units for copying from the fast access tier to the slow access tier, according to embodiments of the invention;

FIG. 5 schematically illustrates a method for data placement in a file system based on inter-file hints, according to embodiments of the invention;

FIG. 6 schematically illustrates a method including maintaining the fast access tier into lists; and

FIG. 7 schematically illustrates a method for data placement in a file system based on a close request, according to embodiments of the invention.

### DETAILED DESCRIPTION

Computer files consist of “packages” of information or data units which typically include an array of bytes. Thus, data units are subsets of a file. Some system calls (which provide an interface between a process and the operating system) operate at the file level and other system calls may operate at the byte level. For example, the “open” or “close” system calls (typically used with POSIX-compliant operating systems) initialize or terminate access to a file in a file system, whereas a “read” or “write” system call accesses bytes in a file provided by the “open” call.

Embodiments of the invention relate to a system and method for placement of data in a file system based on hints derived from file level operations, namely system calls, such as “open” and “close”, which do not operate at the data unit granularity but rather operate on whole files.

An exemplary system and exemplary methods according to embodiments of the invention will be described below. For simplicity, LINUX semantics are used to exemplify embodiments of the invention however it should be appreciated that same concepts also apply to other operating systems.

Different embodiments are disclosed herein. Features of certain embodiments may be combined with features of other embodiments; thus certain embodiments may be combinations of features of multiple embodiments.

In the following description, various aspects of the invention will be described. For purposes of explanation, specific configurations and details are set forth in order to provide a thorough understanding of the invention. However, it will also be apparent to one skilled in the art that the invention may be practiced without the specific details presented herein. Furthermore, well known features may be omitted or simplified in order not to obscure the invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

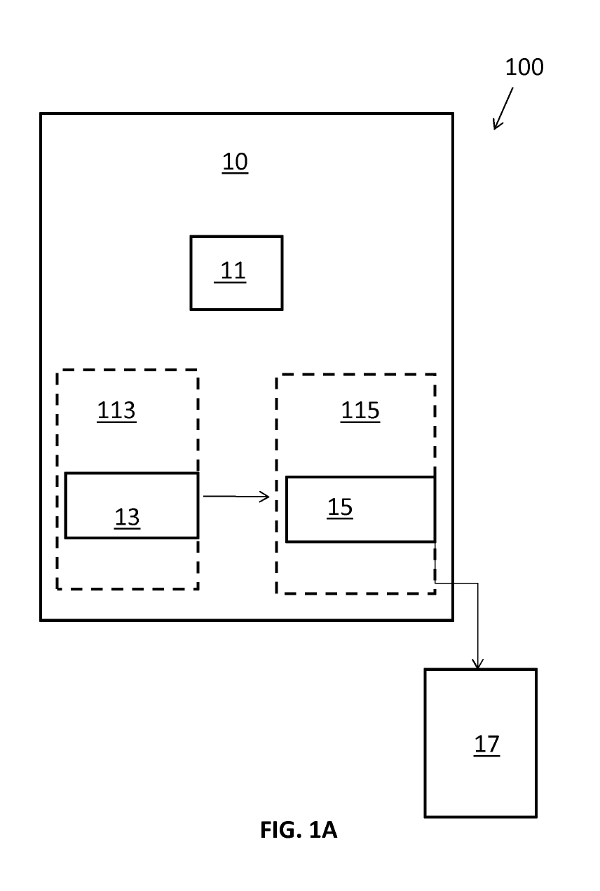

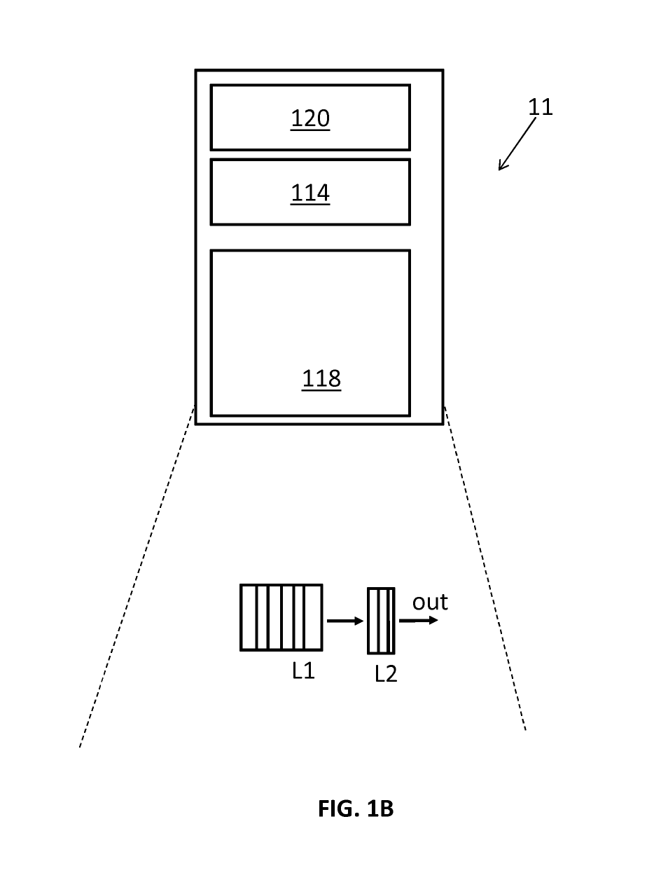

FIGS. 1A and 1B schematically illustrate an exemplary system according to embodiments of the invention.

FIG. 1A shows an exemplary high-level architecture of a computer data storage system 100, which includes a memory aware or memory based file system according to embodiments of the invention.

According to one embodiment the system 100 includes an apparatus such as a node 10 (e.g., a server) having at least one central processing unit (CPU) core 11 and which includes a plurality of storage type devices. Each storage type device or devices may make up a tier. The embodiment illustrated in FIG. 1A shows three tiers however a system according to embodiments of the invention may include more or less tiers.

In one embodiment a first tier 113 is a fast access tier which may include one or more storage devices of the same type. In one embodiment tier 113 includes one or more non-volatile memory device(s) 13 (e.g., non-volatile dual in-line memory module (NVDIMM), or non-volatile memory card or brick over PCIe or Infiniband or another, possibly proprietary ultra-low latency interconnect), which may also be referred to as fast persistent memory (PM). A second tier 115 is a relatively slower access tier which may include one or more storage devices of a different type than the storage devices in tier 113. In one embodiment tier 115 includes a storage device 15 (e.g., Flash-based SSD or a slow PM; a local device or a remote device such as a memory brick or via a fast block service such as FC, FCoIB, FCoE and ISCSI). A third, much slower tier may include an over the network service system 17 (such as NFS, SMB, ISCSI, Ceph, S3, Swift and other RESTful object services).

A fast access storage type device (e.g., non-volatile memory device 13) may be, for example, 1,000 faster per access than the slower access storage type device (e.g., device 15).

System 100 may include additional memories and storage devices, a network interface card (NIC) and possibly other peripherals (e.g., cards and/or chips) (not shown).

Data units, which are subsets of a file, may be stored in different storage devices and in different tiers.

Embodiments of the invention enable keeping “non-cold” data on relatively fast tiers (e.g., in non-volatile memory 13 and/or in storage device 15) as opposed to very slow and typically over the network service system 17 while separating the non-cold data to “hot” data (e.g., data requested multiple times within the past minutes) which can be stored in a first fast access tier and “warm” data (e.g., data accessed multiple times within the past week) which can be stored in a second, slower access tier.

According to embodiments of the invention the CPU 11 can copy or move a data unit from the second tier 115 to the first tier 113 based on a hint derived from a file level operation. In one embodiment once a file level operation (such as an open system call) occurs, even prior to an actual access request to a data unit, a speculated access request to the data unit is issued. Based on the issuing of the speculated access request a decision may be made to copy the data unit from a relatively slower access tier (e.g., second tier 115) to a faster access tier (e.g., first tier 113).

In an exemplary architecture schematically illustrated in FIG. 1B CPU 11 runs one or more applications 120 that use a file system 118 to store and retrieve data, typically through a standard interface 114, such as POSIX. File system 118, which may be stored in one or more storage devices (e.g., in non-volatile memory 13 and/or in storage device 15 and/or in other memories or storage devices), may use the components described in system 100 to store data.

Once a data unit has been copied from the relatively slow access tier to the fast access tier, the data unit may be managed in the fast access tier to ensure that it stays in the fast access tier only as long as needed. Data units may be managed in the fast access tier in lists.

A list, in the context of the invention, refers to a data structure consisting of a group of nodes which together represent a sequence having a beginning (head) and end (tail). Basically, each node may include data or a representation of data, and includes a reference or link (e.g., a pointer or means to calculate a pointer) to the next node in the sequence. Also, a list may include data units or only descriptors (e.g., pointers) of data units whereas the data units themselves may be kept elsewhere.

Typically, data units are input to the head of a list and are pushed along the sequence towards the tail of the list by new data units entering the head of the list. Once the memory is full, or a certain capacity threshold is crossed, one or more data units must be moved out of the memory before a new data unit can be moved in. The data units moved out of the memory are typically the data units at the tail of the list. Some lists may be managed as first in first out (FIFO). Other lists may be managed based on an access pattern. For example, once a data unit is requested or accessed it may be moved out of its place in the list to the head of the list and may then be pushed through the list as new data units are added. This scheme, ensures that the most recently used data units are at the head of the list thus staying in the memory at least until they reach the tail of the list where, as they are the least recently requested/used data units, they are removed from the list.

According to one embodiment the file system 118 maintains a memory (e.g., non-volatile memory 13) in the fast tier into lists of data units, e.g., lists L1 and L2. In one embodiment data units that were actually accessed are maintained in a first list in the fast access tier and data units that were issued a speculated access request are maintained in a second list in the fast access tier. Data units pushed through the second list without having been accessed eventually reach the tail of the list after which they are moved out of the second list and out of the fast access tier. However, data units in the second list may be moved to the head of the first list upon access.

Thus, data units issued a speculated access are kept in the fast access tier less time than data units that are actually accessed.

In one embodiment system 100 includes a software programming code or computer program product that is typically embedded within, or installed on a computer. Alternatively, components of system 100 can be stored in a suitable storage medium such as, a CD, a drive (e.g., HDD, SSD, DOM), memory stick, remote console or like devices.

Embodiments of the invention may include an article such as a computer or processor readable non-transitory storage medium, such as for example a memory, a drive, or a USB flash memory encoding, including or storing instructions, e.g., computer-executable instructions, which when executed by a processor or controller, cause the processor or controller to carry out methods disclosed herein.

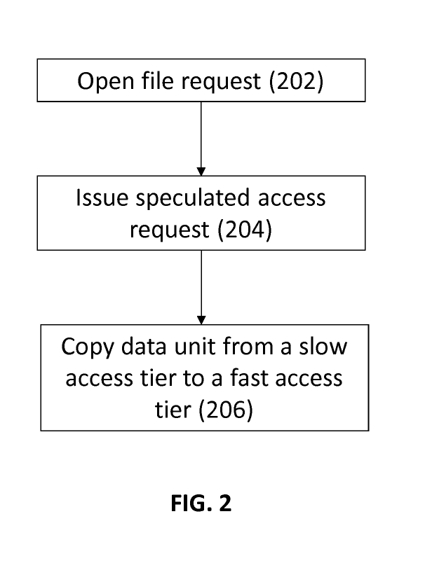

A method for data placement in a file system, according to one embodiment of the invention, is schematically illustrated in FIG. 2. Based on a file open request to the file (202) a speculated access request is issued to a data unit (which is a subset of the file) (204) and the data unit is copied from a slow access tier (e.g., second tier 115) to a fast access tier (e.g., first tier 113) based on the issuing of the speculated access request (206).

Meta data belonging to the file (typically indirect blocks connecting the file iNode and its data units) may reside in the fast access tier even if the data itself is not in that tier. In cases where the meta data belonging to the file resides in a slow access tier the meta data may be moved or copied to a faster access tier based on a file open request to the file.

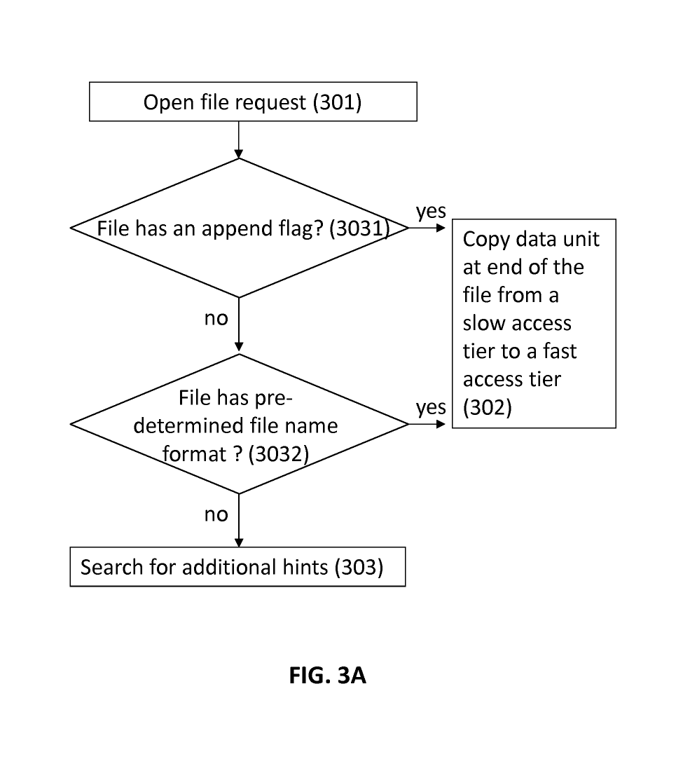

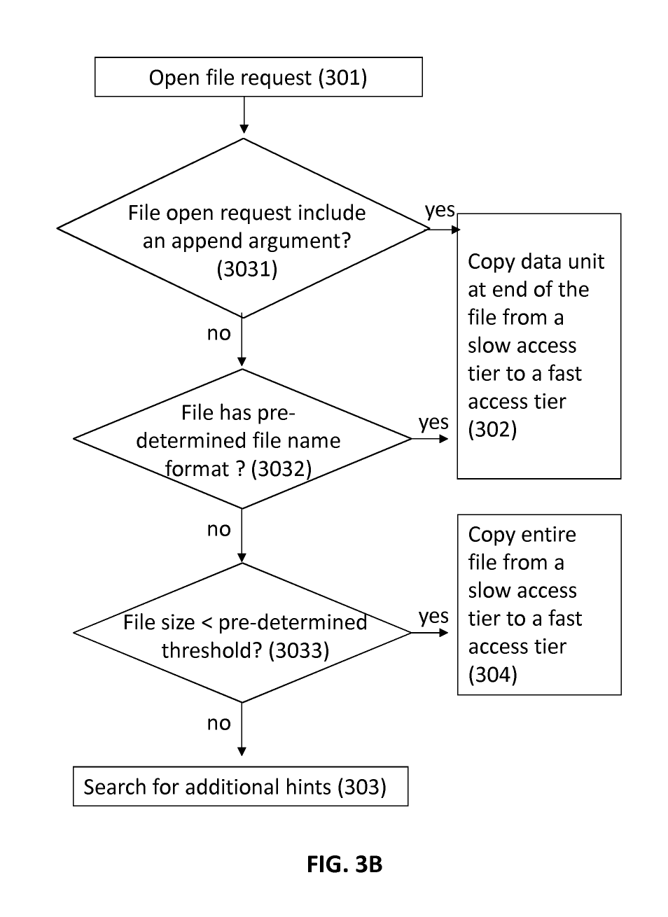

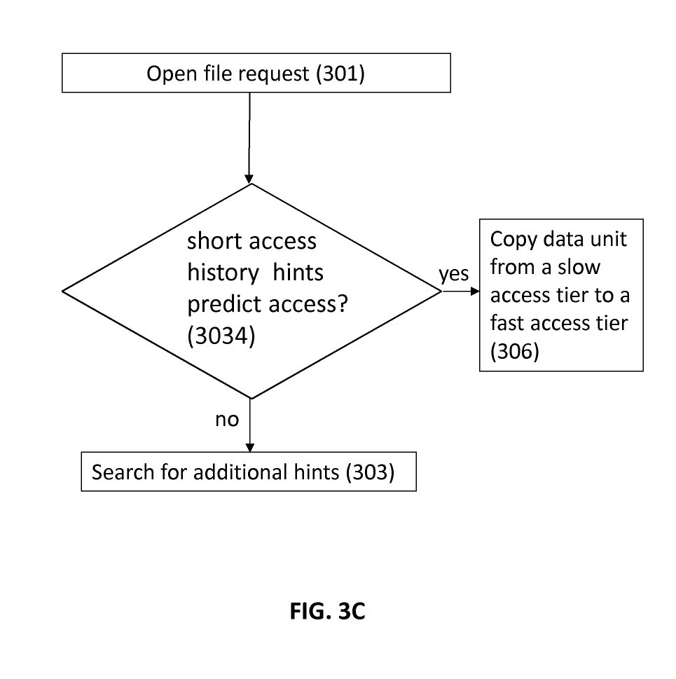

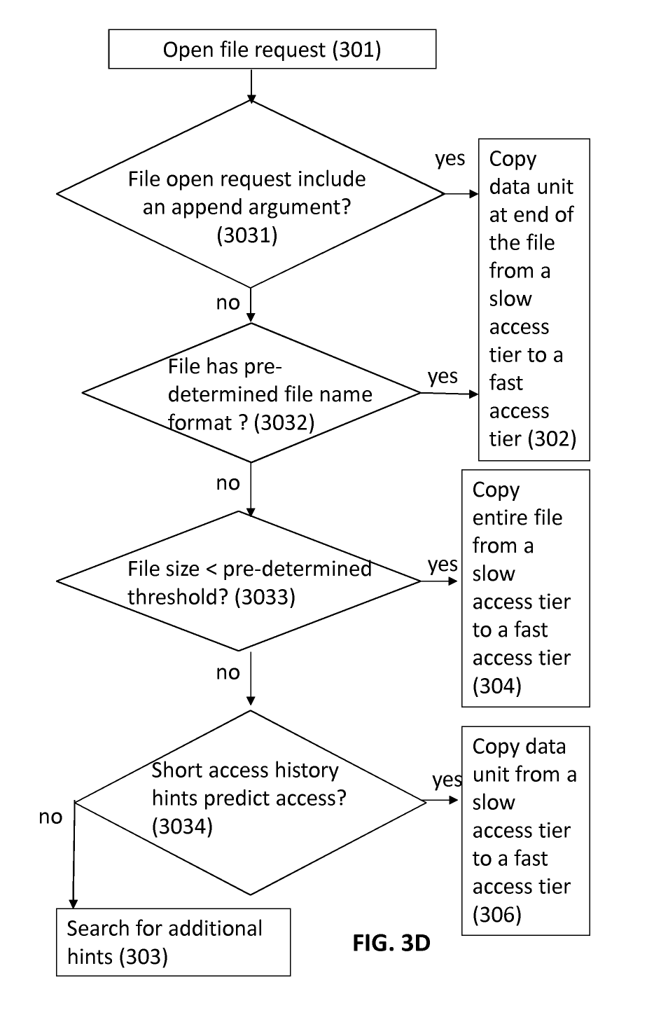

Issuing a speculated access request to a certain data unit in the file may be based on a hint derived from the open request operation (e.g., an argument in the open system call) and from intra-file characteristics, as schematically described in FIGS. 3A-3C.

For example, as schematically illustrated in FIG. 3A, a file open request (301) may include an append argument, such that the file has an append flag (3031) in which case the step of copying a data unit from the slow access tier to the fast access tier includes copying the last data unit from the end of the file (302).

An open request which includes an append argument will cause a file to be opened in append mode in which each new data unit accessed (e.g., based on a read or write system call) will typically be added to the end of the file. Typically, a data unit may be of fixed size whereas a file typically has an arbitrary size. In many cases the end of the file is misaligned with boundaries of the data unit. These cases may provide a hint that the data unit at the end of the file will probably be accessed soon, indicating that the data unit at the end of the file (which was opened with an append argument) should be issued a speculated access request and consequently copied from the slower access tier to the fast access tier. For example, the following function may be applied: If ((Append_argument==1) and ((filesize modulo data_unit_size) !=0)) then issue a speculated access request to the last data unit of the file.

When the end of the file is aligned with boundaries of the data unit this may imply that there is no need to copy data units from the slow access tier to the fast access tier. Moreover, as detailed below, if there is only one process using the file at a given moment, other data units in the file can be marked for being moved “down” from the fast access tier to a slower access tier.

In some cases, if the file open request does not include an append argument (3031), the file name or file extension may be used to provide a hint that the data unit at the end of the file will probably be accessed soon or next, indicating that the data unit at the end of the file should be copied from the slow access tier to the fast access tier (302).

For example, files having a file name extension that matches a pre-defined set of name extensions may provide a hint as to a data unit that should be copied from the slow access tier to the fast access tier. For example, file name extensions implying an “append” pattern (such as the extension “.log”) may typically indicate that items or data units are to be added sequentially into the file. Thus, if a file has a pre-determined file name format (3032) (such as a file having a “.log” name extension) the data unit at the end of the file is issued a speculated access request and is consequently copied from the slow access tier to the fast access tier (302).

In one embodiment a pre-determined file name format is a name format that matches a pre-defined set of name extensions, e.g., name extensions listed in a pre-constructed table of file name extensions.

If an open file request does not include an append argument and/or does not have a pre-determined file name, additional hints may be searched (303) or a decision may be made that no data unit is copied from the slow access tier to the fast access tier.

In some cases, as schematically illustrated in FIG. 3B, even if the file open request (301) does not include an append argument (3031) and the file name format or file extension is not a pre-determined name format (3032) the whole file may be copied from the slow access tier to the fast access tier (304) if the file size is below a pre-determined threshold (3033), for example, the threshold may be a certain amount of data units (e.g. 2) in size.

If an open file request does not include an append argument and/or does not have a pre-determined file name and the file is large (above the pre-determined threshold) then additional hints may be searched (303) or a decision may be made that no data unit is copied from the slow access tier to the fast access tier.

In another embodiment, schematically illustrated in FIG. 3C, a speculated access request may be issued based on a short history of access to the file. A short history of accesses (which may be maintained per access) may include a limited number of latest events in the file, such as read or write accesses and their associated arguments, such as offset, I/O size, etc., as further detailed below.

The analysis of a short history of accesses may provide hints of predicted access. In one example a short history of accesses per file may include a table of the last number (e.g. 4) of accesses per file where each table line may record events or parameters such as a coarse grained timestamp for file open request, the flags used for opening the file (e.g. append), a counter for the number of times the file received read access requests, a counter for the number of times the file received write access requests, up to N or all offsets used during I/O accesses and up to N or all I/O sizes used during I/O accesses.

Some of these parameters may be maintained in a highly compact predictor and not as raw data. For example, a 1-bit or 2-bit counter may represent random or sequential reads. For each small I/O size read access the counter may be incremented (e.g., up to the saturated binary value of “11”), and for each large I/O size read access the counter may be decremented (e.g., down to the saturated binary value of “00”). When a small vs. large I/O prediction is required for the next I/O access, the most significant bit of the 2-bit counter is used, e.g. if counter==“1x” (x represents a “don't care” value, so “10” or “11”) the prediction is small I/O, otherwise (“0x”) large I/O.

Predicting other binary events, such as whether the next write will be done to the first data unit of a file, to the last data unit, whether it will be a read request, etc. may be done with additional small saturating counters in a similar manner, rewarding opposite behaviors by incrementing or decrementing the counter.

In another embodiment some of these parameters may be maintained in a set of counters, meant to distinguish between different file open requests and/or process IDs (PID). For example, a number (C) of 2-bit saturating counters may be used (as described above), but one counter is selected, e.g., by using a hash function on the PID. Various hash functions can be used: the enumerated I/O access since the last open request modulus some constant C; the requesting PID modulus C, or even a combination (e.g. (enumerated I/O access XOR the PID modulus C).

In some embodiments, based on an open file request (301) and if the short history of accesses provides a hint of predicted access (3034) then a speculated access may be issued to a data unit based on the hint and the data unit may be copied from a slow access tier to a fast access tier (306). For example, a file comprised of a data structure of keys in data units 1-4 and value blobs in data units 5-1000, may have an access pattern or frequency counters showing that data units 1 and 2 may be worth keeping in the fastest access tier. The access pattern implementation could show for example: open, 2, 347, close, open, 1, 97, close, open, 2, 321, close, open 1, 126, close, open, 1, 170, close, etc. The frequency counters implementation for the same example could show: counted 3 times: #1, counted 2 times: #2, counted 1 time: #97, #126, #170, #321, #347.

If the short history of accesses does not provide a hint of predicted access (3034), additional hints may be searched (303) or a decision may be made that no data unit is copied from the slow access tier to the fast access tier.

In another embodiment, which is schematically illustrated in FIG. 3D, a file open request (301) may include an append argument (3031) in which case the step of copying a data unit from the slow access tier to the fast access tier includes copying a data unit from the end of the file (302). If the file open request does not include an append argument (3031) the file name or file extension may be used to provide a hint indicating that the data unit at the end of the file should be copied from the slow access tier to the fast access tier (302). If the file open request (301) does not include an append argument (3031) and the file name format or file extension is not a pre-determined name format (3032) the whole file may be copied from the slow access tier to the fast access tier (304) if the file size is below a pre-determined threshold (3033). If none of the above conditions are fulfilled, a short history of accesses may be searched for a hint of predicted access. If there is a hint of predicted access in the short history of accesses (3034) then a speculated access may be issued to a data unit based on the hint and the data unit may be copied from a slow access tier to a fast access tier (306).

If none of the above intra-file characteristics produce a hint for predicted access, additional hints may be searched (303) or a decision may be made that no data unit is copied from the slow access tier to the fast access tier.

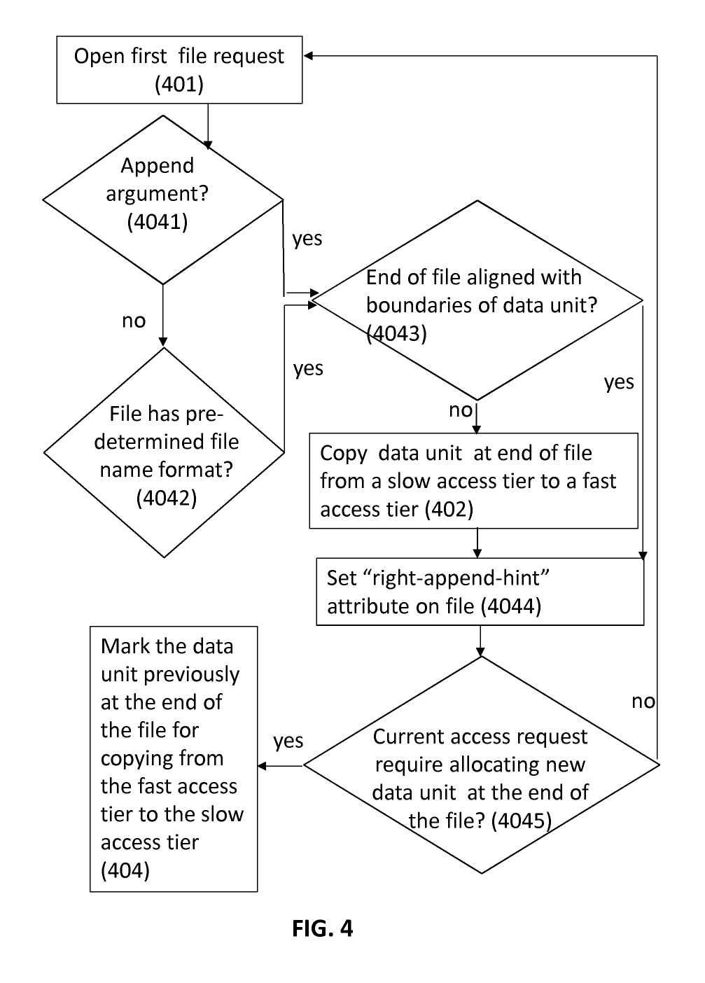

In one embodiment which is schematically illustrated in FIG. 4, after a file open request (401) it is determined if the open request includes an append argument (4041). If the open request includes an append argument it is determined if the end of the file is aligned with boundaries of the data unit (4043) in which case a “right-append-hint” attribute may be set on the file (4044) and based on the right-append-hint attribute and on a current access request to the file, if the request requires allocating new data unit at the end of the file (4045) (e.g., a write request to the end of the file), a new data unit may be allocated at the end of the file and the data unit previously at the end of the file is marked for copying or moving “down” from the fast access tier to the slow access tier (404).

If the end of the file is misaligned with boundaries of the data unit the step of copying a data unit from the slow access tier to the fast access tier includes copying a data unit from the end of the file from a slow access tier to a fast access tier (402) after which a “right-append-hint” attribute may be set on the file and a data unit may be marked for copying from the fast access tier to the slow access tier, as described above.

If the open request does not include an append argument it may be determined if the file has a file name extension that matches a pre-defined set of name extensions (4042) (e.g., as described above). If the file name extension or file name format matches a pre-defined set of name extensions and the end of the file is aligned with boundaries of the data unit (4043), a “right-append-hint” attribute may then be set on the file (4044) and based on the right-append-hint attribute and on a current access request to the file, if the request requires allocating a new data unit at the end of the file (4045) (e.g., a write request to the end of the file), a new data unit may be allocated at the end of the file and the data unit previously at the end of the file may be marked for copying or being moved “down” from the fast access tier to the slow access tier (404).

Thus, a “right-append-hint” attribute may be set on the file (4044) based on an extension name of the file (e.g., based on extensions hinting at an append pattern, as described above), based on flags of the file or based on other hints provided by the file open request.

In an alternative embodiment the method may include setting a “left-append-hint” attribute on the file after a number (e.g. 2) of requests that add a data unit to the beginning of the file (e.g., FALLOC_FL_INSERT_RANGE). Based on the left-append-hint attribute and following an access request (e.g., a write request to the beginning of the file) or another FALLOC_FL_INSERT_RANGE request to add a data unit to the beginning of the file, the data unit previously at the beginning of the file may be marked for copying from the fast access tier to the slow access tier.

Marking a data unit for copying from the fast access tier to the slow access tier may include moving the data unit to a possibly dedicated list maintained in the fast access tier. Data units in the list are moved from the head of the list to the tail of the list and from the tail of the list out of the fast access tier to the slow access tier. The list may be managed based on an access pattern, e.g., as described above.

In one embodiment a plurality of lists may be maintained in the fast access tier, e.g., lists L1 and L2 in FIG. 1B. The lists may be managed based on an access pattern. Thus, for example, data units may be moved to the head of L2 because they are marked for being copied from the fast access tier to the slow access tier. The data units are pushed through the list L2 towards the tail of the list and, if they are not accessed while in the list L2, they are moved from the tail of the list to the slow access tier. A data unit that is accessed while in the list L2 may be moved out of L2 to the head of the L1 list thereby being maintained in the fast access tier instead of being copied or moved to the slow access tier.

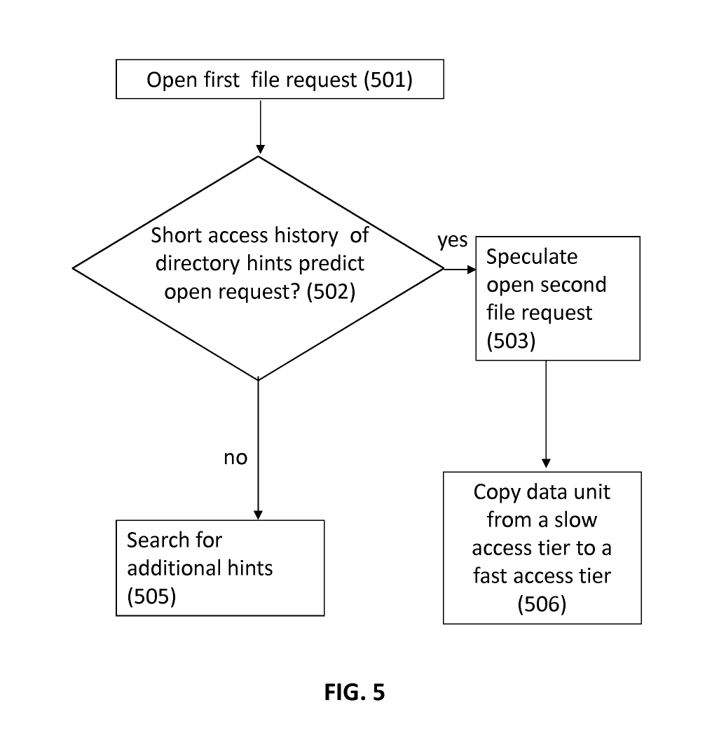

Methods according to embodiments of the invention may include issuing a speculated access request to a certain data unit in the file based on a hint derived from inter-file characteristics, e.g., hints from another file or hints from within a directory, as schematically described in FIG. 5.

According to one embodiment based on a file open request to a first file in a directory (501), a speculated file open request may be issued to a second file in the directory (503). A speculated access request may be issued based on the speculated file open request and a data unit may be copied from the slow access tier to the fast access tier (506) based on the speculated access.

Similarly to the case described above, when meta data belonging to a first file resides in a slow access tier the meta data may be moved or copied to a faster access tier based on a file open request to a second file.

The speculated file open request may be issued based on information from within the directory.

If information from within the directory predicts a file open request, then a speculated file open request may be issued. For example, information from the directory may be found in a short history of file open requests in the directory (typically a history of a limited time interval) and a speculated file open request may be issued based on the short history of open file requests.

A short history of open file requests may be maintained as described above but not per file, rather per directory or even globally. In this case, the number of counters (C) would typically be a lot larger than the number used to maintain a short access history per file, and file or directory iNode numbers could be used as input to the hash function.

In one example a table of the last D file accesses may be maintained per directory and each table line may record events or parameters such as a coarse grained timestamp for main file system calls: open, close, read and write, the arguments used for opening the file (e.g. write append), the file extension or a prediction as to its type of content, a counter for the number of times the file received read access requests and a counter for the number of times the file received write access requests. In another embodiment the short history of open file requests may be maintained as periodically reset counters, counting for example the number of files with “.db” file extension that were requested to be open in the last time interval. In one embodiment an action (such as invoking similar operations of copying a data unit from the slow access tier to the fast access tier) can be made for similar files if the counter crosses an absolute threshold (e.g. 5) or a relative one (e.g. 4%), or both.

If the short access history of file open requests in the directory hints at a predicted open request (502) then a speculated file open request may be issued (503). A speculated access request may be issued based on the speculated file open request and a data unit may be copied from the slow access tier to the fast access tier (506) based on the speculated access. If information from within the directory does not predict a file open request then additional hints may be searched (505) or a decision may be made that no data unit is copied from the slow access tier to the fast access tier.

In some embodiments a speculated argument may be issued based on the speculated file open request and the speculated access request is issued based on the speculated argument. For example, a speculated append argument may be issued based on a speculated file open request which is based on a history of open requests exclusively to files having an append pattern (e.g., as determined based on the file name extension).

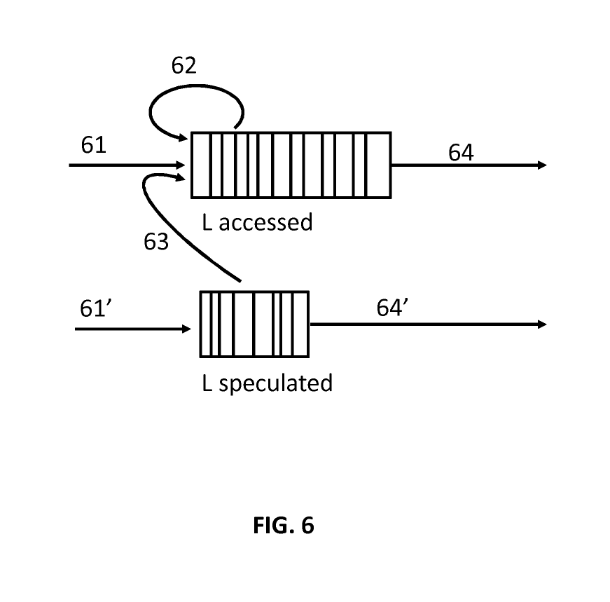

In some embodiments the fast access tier, typically a PM device, is maintained into lists, as described above. In one embodiment, which is schematically illustrated in FIG. 6, several lists may be maintained. Data units that were actually accessed (as opposed to data units that were issued a speculated access) may be maintained in a first list (Laccessed) and data units that were issued a speculated access request may be maintained in a second list (Lspeculated), until their speculation is proven useful or fruitless. Data units at the tail of Laccessed and Lspeculated are typically removed from the fast access tier. In another embodiment a third list or additional lists may be maintained for data units being pushed out of Laccessed and Lspeculated such that data units pushed out of the tail of Laccessed and Lspeculated may be retained in the fast access tier a while longer before being removed from the fast access tier. In some embodiments data units that are accessed while moving through a third list may be moved from the third list to the head of the first list.

Data units that were accessed may be copied or moved from a slow access tier into Laccessed, as indicated by arrow 61. Data units that were issued a speculated access may be moved into Lspeculated, as indicated by arrow 61′. The first list (Laccessed) may be managed based on access pattern, e.g., a repeated access pattern. Thus, when a data unit is accessed while in the first list it may be moved to the head of the first list as indicated by arrow 62, and may then be pushed through the list until it is moved from the tail of the first list, as indicated by arrow 64.

Data units that were issued a speculated access are pushed through the second list (Lspeculated) but may be moved from the second list to the head of the first list upon an access request while they are in the second list, as indicated by arrow 63.

Data units that were issued a speculated access and were pushed through the second list without being accessed, are typically pushed out of the second list, as indicated by arrow 64′. As discussed above data units pushed out of the two lists may be eventually moved from the fast access tier to the slow access tier.

Thus, data units that are actually accessed are typically maintained in the fast access tier longer than data units that were issued a speculated access.

In some embodiments data units are marked for being moved from the fast access tier to the slow access tier based on a close file system call.

In one embodiment, upon a final close request to a file, meaning that there are no users that still have the file open, all the data units of the file which are saved in the fast access tier are marked for being moved from the fast access tier to the slow access tier.

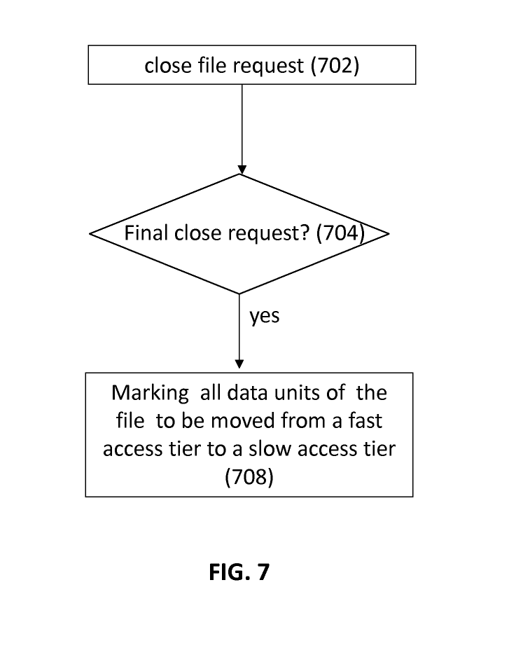

A method for data placement in a file system according to one embodiment of the invention is schematically illustrated in FIG. 7. The method includes receiving a close request for a file (702) and determining whether the close request is the final close request (704) (e.g., there are no users that still have the file open). Based on the final close request to the file, marking all data units of the file which are saved in a fast access tier (e.g., tier 113 in FIG. 1A), for being moved from the fast access tier to a slower access tier (e.g., tier 115 in FIG. 1A).

The fast access tier may be maintained into a list of data units, as described above. Marking all data units of the file may include moving all the data units of the file to the tail of their list. In another embodiment marking all data units may include moving the data units into a dedicated list which may be maintained based on an access pattern or based on other policies as described above (e.g., in FIG. 6). Thus, based on a file close request, all the data units related to the file may be retained in the fast access tier for a while (e.g., while moving through a dedicated list) but will be eventually moved out of the fast access tier to the slow access tier if they are not accessed again.

In one embodiment access to the data unit while in the list (e.g., a dedicated list for data units marked for being moved from the fast access tier to a slower access tier) may include issuing a speculated access to the data unit based on a file open request to a file containing the data unit, as described above, for example, with reference to FIG. 3D.

The system and methods according to embodiments of the invention provide a solution for increasing demand in performance, capacity and ease of management of data in data storage systems.

What is claimed is:

1. A method for data placement in a file system, the method comprising:
issuing a speculated access request to a data unit, the data unit being a subset of a file, based on a file open request to the file; and
copying the data unit from a slow access tier to a fast access tier based on the issuing of the speculated access request.

2. The method of claim 1 wherein the file open request comprises an append argument and wherein copying the data unit from the slow access tier to the fast access tier comprises copying a data unit from the end of the file.

3. The method of claim 2 wherein the end of the file is misaligned with boundaries of the data unit.

4. The method of claim 3, further comprising:
setting a right-append-hint attribute on the file after the file open request;
based on the right-append-hint attribute and on an access request allocating a new data unit at the end of the file; and
marking a data unit previously at the end of the file for copying from the fast access tier to the slow access tier.

5. The method of claim 1 wherein the file has a file name extension that matches a pre-defined set of name extensions.

6. The method of claim 1 wherein the speculated access request is issued based on a short history of access to the file.

7. The method of claim 6, further comprising:
setting a left-append-hint attribute on the file after the file open request; and
based on the left-append-hint attribute and following an access request, allocating a new data unit at the beginning of the file and marking a data unit previously at the beginning of the file for copying from the fast access tier to the slow access tier.

8. The method of claim 1, further comprising:
determining if the file open request comprises an append argument; if not
determining if the file has a file name extension that matches a pre-defined set of name extensions; if not
determining if the file is of size smaller than a pre-determined threshold; and if not issuing the speculated access request based on a short history of access to the file.

9. The method of claim 1, further comprising:
based on a file open request to a first file in a directory, issuing a speculated file open request to a second file in the directory; and
issuing a speculated access request based on the speculated file open request.

10. The method of claim 9 wherein the speculated file open request is issued based on a short history of open file requests.

11. The method of claim 9 comprising issuing a speculated argument based on the speculated file open request and issuing the speculated access request based on the speculated argument.

12. The method of claim 1 comprising maintaining data units that were accessed in a first list in the fast access tier and maintaining data units that were issued a speculated access request in a second list in the fast access tier wherein data units in the second list are moved to the head of the first list upon an access request.

13. The method of claim 1, further comprising:
based on a final close request to the file, marking all data units of the file which are saved in the fast access tier, for being moved from the fast access tier to the slow access tier.

14. A method for data placement in a file system, the method comprising:
based on a final close request to a file, marking all data units of the file which are saved in a fast access tier, for being moved from the fast access tier to a slower access tier.

15. The method of claim 14 comprising maintaining the fast access tier into a list of data units in which data units are moved from the head of the list to the tail of the list and from the tail of the list to the slower access tier, and wherein marking all data units of the file comprises moving all the data units of the file into the list.

16. The method of claim 15, further comprising:
moving a data unit from the list upon access to the data unit; and
maintaining the data unit in the fast access tier.

17. The method of claim 16 wherein access to the data unit comprises issuing a speculated access to the data unit based on a file open request to a file containing the data unit.

18. A data storage system comprising:
a fast access storage device;
a slower access storage device; and
a processor to
issue a speculated access request to a data unit, the data unit being a subset of a file, based on a file open request to the file; and
copy the data unit from the slower access storage device to the fast access storage device based on the issuing of the speculated access request.

19. The data storage system of claim 18 wherein the fast access storage device comprises a non-volatile PM module.
